(19) United States
(12) Patent Application Publication
(10) Pub. No.: US 2010/0012433 A1
(43) Pub. Date: Jan. 21, 2010

(54) Self-locking extendable ladder for use with a boat

(75) Inventors: Joseph M. Ross, Pepper Pike, OH (US); Xingtao Wang, Jiangmen City (CN)

Correspondence Address: SAND & SEBOLT, AEGIS TOWER, SUITE 1100, 4940 MUNSON STREET, NW, CANTON, OH, 44718-3615, US

(73) Assignee: Challenger Hardware Company, Beachwood, OH (US)

(21) Appl. No.: 12/287,474

(22) Filed: Oct. 9, 2008

Related U.S. Application Data
(60) Provisional application No. 61/135,308, filed on Jul. 18, 2008.

(51) Int. Cl. E06C 7/06

(52) U.S. Cl. 182/211

(57) ABSTRACT

A telescoping ladder assembly which is especially useful for boarding a boat from the water includes a ladder comprising a plurality of telescoping ladder sections and a securing mechanism for securing the ladder in a stowed position. The securing mechanism includes a spring member which biases the ladder and a stop against one another to prevent extension of the ladder. The ladder is preferably pivotally and slidably mounted on a frame which is configured for mounting on a platform such as the transom of a boat.

### CROSS REFERENCE RELATED TO APPLICATIONS

This application claims priority from U.S. Provisional Application Ser. No. 61/135,308 filed Jul. 18, 2008; the disclosure of which is incorporated herein by reference.

### BACKGROUND OF THE INVENTION

1. Technical Field

The present invention relates generally to ladders. More particularly, the present invention relates to a telescoping ladder such as those typically used on a boat. Specifically, the present invention relates to a telescoping ladder having a locking or securing mechanism for securing the ladder in a stowed position.

2. Background Information

Telescoping ladders are well known in the art, including those which are specifically configured for mounting on a boat or another platform. These telescoping ladders typically include several telescoping ladder sections which allow the ladder to be extended for operational purposes and retracted in order to stow the ladder. However, when such a ladder is in its stowed position, it is not always sufficiently secured, and even if it is secured sufficiently to prevent accidental extension, the ladder tends to rattle during boat travel. There is thus a need in art for a telescoping ladder which may be easily secured in its stowed position in order to prevent accidental extension as well as to prevent rattling of the ladder.

### BRIEF SUMMARY OF THE INVENTION

The present invention provides a telescoping ladder assembly comprising: a first stop; a ladder comprising a plurality of telescoping ladder sections whereby the ladder is telescopically extendable and retractable to respectively lengthen and shorten the ladder; a first one of the ladder sections telescopically movable relative to the first stop; and a spring member which biases the first ladder section and first stop against one another when the ladder is retracted to prevent telescopic extension of the first ladder section.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a side elevational view of the ladder assembly of the present invention shown mounted on the transom of a boat in its fully extended and lowered positions.

FIG. 2 is a perspective view of the ladder assembly in its fully extended and lowered positions.

FIG. 3 is a sectional view taken on line 3-3 of FIG. 2.

FIG. 4 is a side elevational view of the ladder assembly illustrating the pivotal movement of the ladder from its lowered position to its raised position and the telescopic retraction of the ladder as the ladder moves toward its stowed position.

FIG. 5 is similar to FIG. 4 with portions cut away and shows the ladder nearing its stowed position.

FIG. 6 is an enlarged side elevational view of the rear portion of the ladder assembly at the same stage as shown in FIG. 5.

FIG. 6A is similar to FIG. 6 and shows the ladder in its stowed and secured position.

FIG. 7 is a side elevational view with portions cut away of the front of the ladder assembly with the spring assembly shown in section in a stage analogous to that of FIG. 6 showing the spring prior to or at the initial stage of compression.

FIG. 7A is similar to FIG. 7 and shows the spring having been compressed.

FIG. 8 is a perspective view of the ladder assembly in its stowed and secured position.

FIG. 9 is a top plan view of the ladder assembly in its stowed and secured position.

FIG. 10 is similar to FIG. 5 and shows the ladder being forced forward to overcome the spring bias of the spring assembly at an initial stage of moving out of its secured position.

FIG. 11 is an enlarged side elevational view of the front portion of the ladder assembly shown at the same stage as illustrated in FIG. 10.

FIG. 12 is similar to FIG. 10 and illustrates the ladder moving from its stowed position toward its extended and lowered position.

Similar numbers refer to similar parts throughout the drawings.

### DETAILED DESCRIPTION OF THE INVENTION

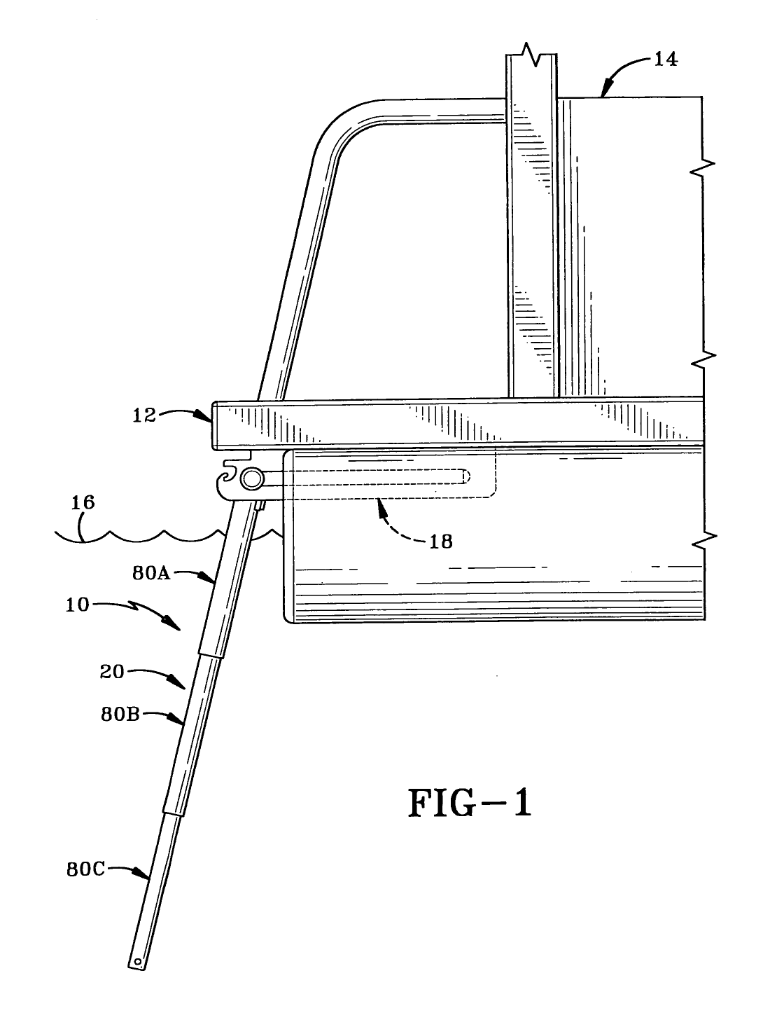

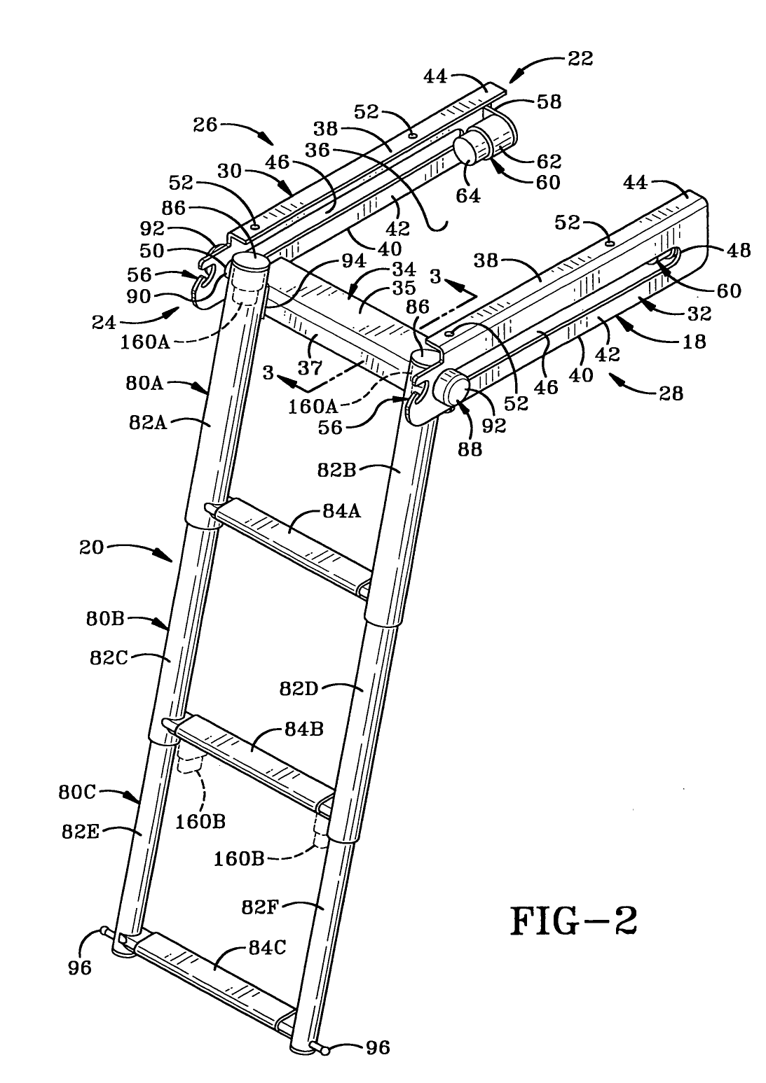

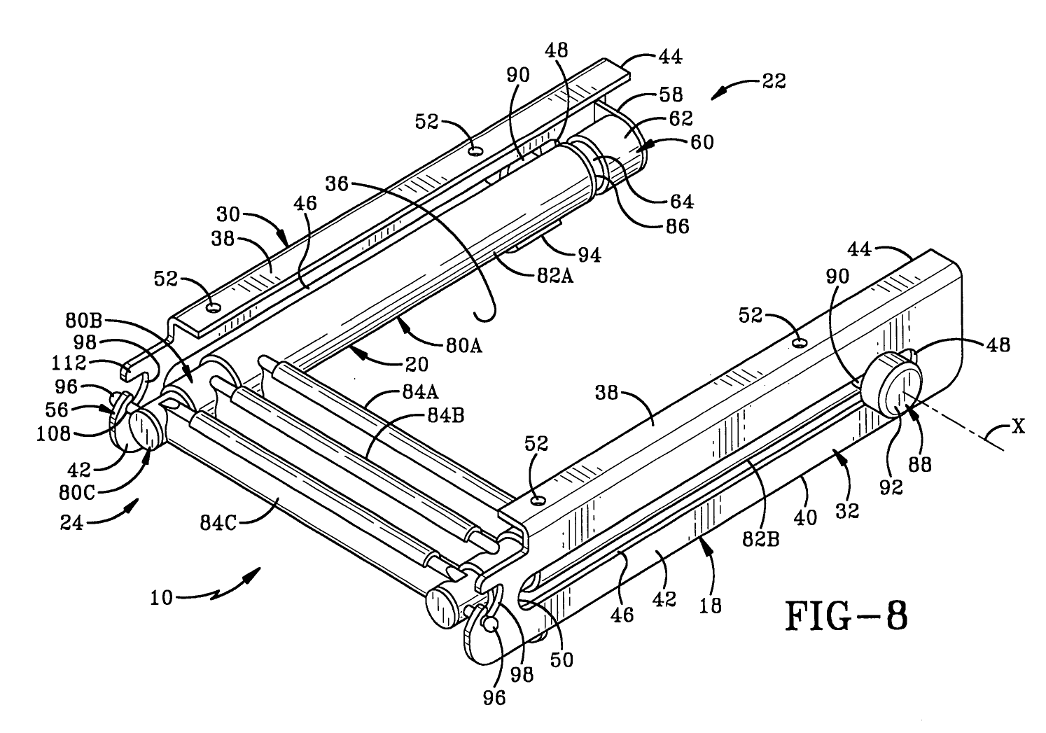

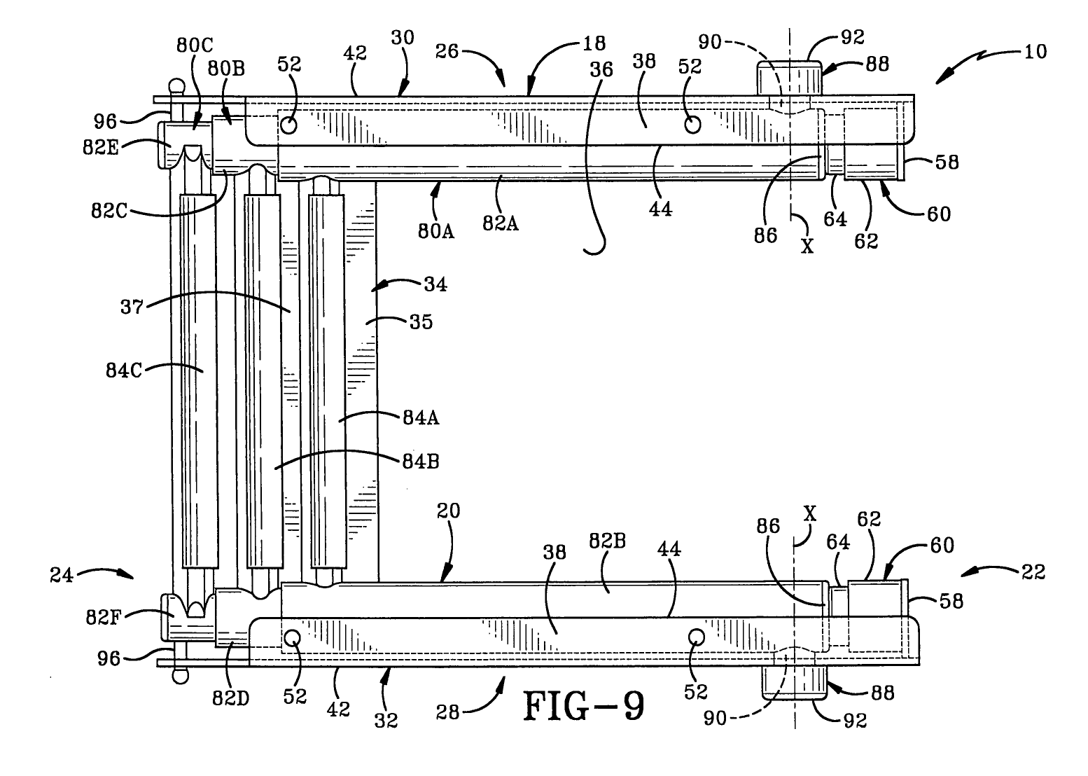

The ladder assembly of the present invention is shown generally at 10 in FIGS. 1 and 2. FIG. 1 shows ladder assembly 10 mounted on the bottom of a transom 12 of a boat 14 shown floating on water 16 so that the ladder extends downwardly from transom 12 into water 16 so that the ladder may be used by an individual to climb out of water 16 onto boat 14. Although ladder assembly 10 is shown mounted on the transom of boat 14, it may be mounted in other locations on a boat or another platform for use in other environments. Ladder assembly 10 includes a rigid frame 18 and a telescoping ladder 20 which is telescopically extendable and retractable to respectively lengthen and shorten the ladder. FIGS. 1 and 2 show ladder 20 in its fully extended and lowered positions while FIGS. 8 and 9 show ladder 20 in its fully retracted and stowed positions.

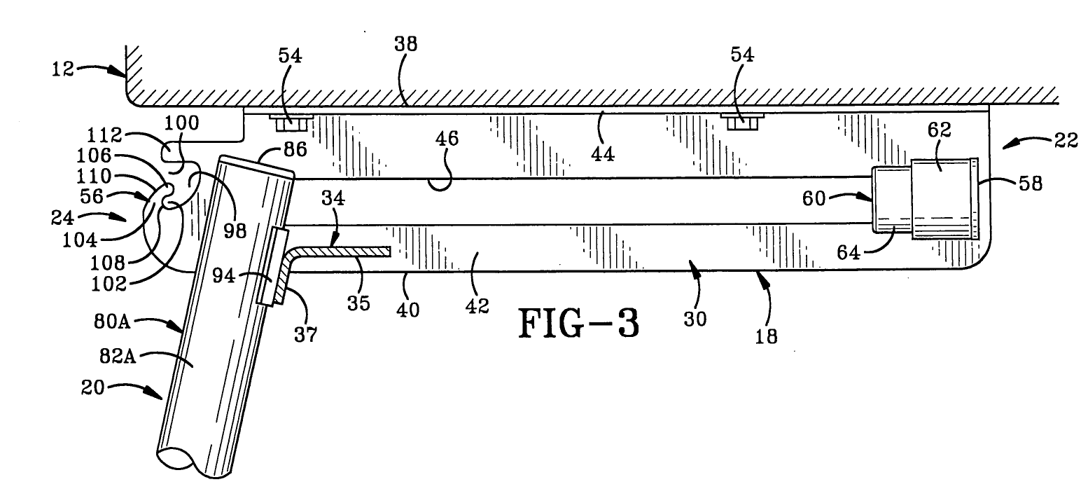

With primary reference to FIG. 2, ladder assembly 10 is described in greater detail. Frame 18 has front and rear ends 22 and 24 defining therebetween a longitudinal direction, and left and right sides 26 and 28 defining therebetween an axial direction. Frame 18 includes parallel left and right longitudinal rails 30 and 32 and an axial crossbar 34 which is rigidly secured to and extends perpendicularly between left and right rails 30 and 32 whereby the rails and crossbar form a generally U-shaped configuration. Crossbar 34 has a generally L-shaped configuration and includes a substantially horizontal top wall 35 and a rear wall 37 which is rigidly connected to the front of top wall 35 and angles downwardly and rearwardly therefrom. Rear wall 37 serves as a ladder support which helps to support ladder 20 in its extended and lowered position. Rails 30 and 32 are axially spaced from one another to define therebetween a space 36 which is primarily forward of crossbar 34. Each of rails 30 and 32 extend from front end 22 to rear end 24. Each of rails 30 and 32 has a top 38 and a bottom 40 whereby top 38 of each rail is typically configured to abut the lower surface of transom 12 when secured thereto. Each rail 30 and 32 has a generally L-shaped configuration as viewed from the front and includes a substantially vertical flat side wall 42 and a top wall 44 or mounting flange which is rigidly secured to the top of side wall 42 and extends perpendicularly thereto toward the other of rails 30 and 32. Side wall 42 extends from front end 22 to rear end 24 while top wall 44 extends from front end 22 to adjacent front end 24, but with its rear end spaced forward thereof. A longitudinally elongated slot 46 is formed in each side wall 42. Each slot 46 has a front end 48 and a rear end 50. A pair of holes 52 is formed through each top wall 44 for receiving therethrough respective fasteners 54 (FIG. 3) typically in the form of bolts or screws which are used to provide a mounting mechanism to rigidly mount frame 18 on the lower surface of transom 12 or another supporting structure or platform. Each sidewall 42 includes a hook 56 adjacent front end 24 which will be described in greater detail further below.

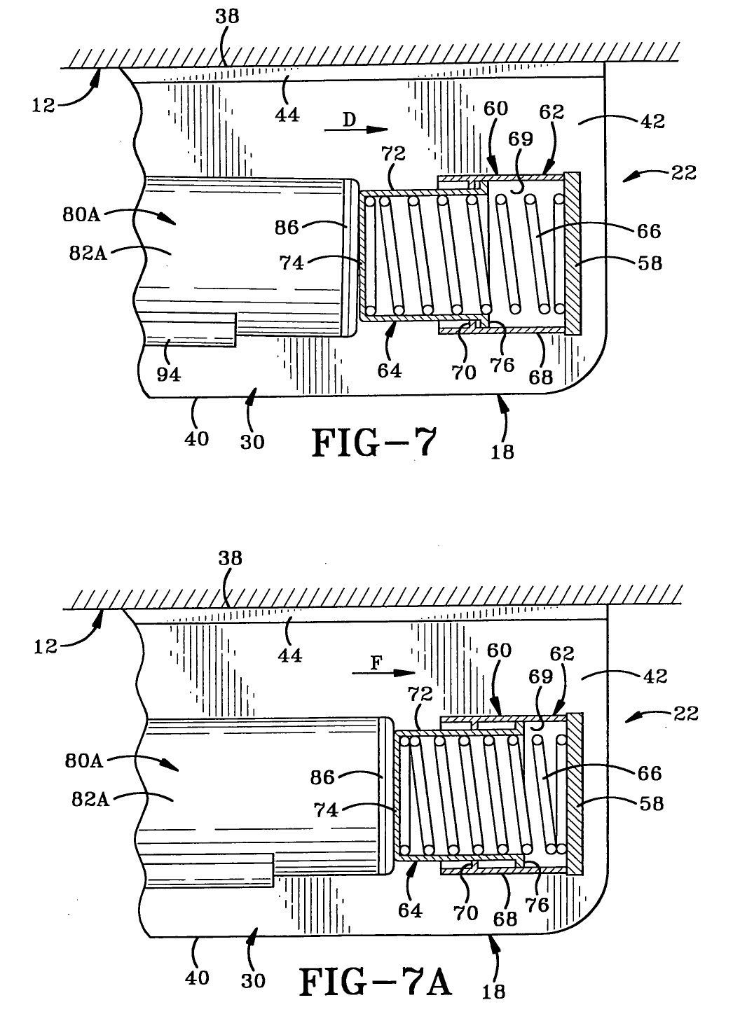

A rigid flange 58 is rigidly connected to and extends from each sidewall 42 adjacent front end 22 into space 36. Each flange 58 serves to mount a force producing mechanism in the form of a spring assembly 60 within space 36 adjacent front end 22 and front end 48 of each slot 46. Spring assembly 60 includes a rigid stationary cylindrical member 62 which is rigidly mounted on flange 58 and extends rearwardly therefrom. Spring assembly 60 further includes a rigid movable member 64 which is movably mounted on cylindrical member 62 and in the exemplary embodiment has a cup-shaped structure. More particularly, member 64 is telescopically received within cylindrical member 62 and moves relative thereto forward and backward along a substantially linear path. Movable member 64 is biased to a rearward position by an internal spring 66 (FIG. 7) which is disposed within cylindrical member 62 and the cavity of movable member 64 with its front end abutting flange 58 and its rear end abutting the front wall of movable member 64.

Referring momentarily to FIG. 7, the structure of the spring assembly 60 is described in greater detail. Cylindrical member 62 includes a cylindrical side wall 68 defining an interior chamber 69 which is bounded by wall or flange 58 at its front end. Member 62 further includes an annular flange 70 which is rigidly secured to and extends radially inwardly from side wall 68 and is spaced rearwardly from flange 58. Movable member 64 includes a cylindrical side wall 72 and a circular rear end wall 74 rigidly secured to the rear end of side wall 72. Movable member 64 further includes an annular flange 76 which is rigidly connected to the front end of side wall 72 and extends radially outwardly therefrom within interior chamber 69. Annular flange 70 serves as a stop which is engaged by annular flange 76 to limit the rearward movement of movable member 64. Spring 66 biases movable member 64 rearwardly so that annular flange 76 normally abuts annular flange 70.

Returning now to FIG. 2, ladder 20 is described in greater detail. Ladder 20 includes three telescoping ladder sections 80A-C so that ladder sections 80A and 80C serve as opposed terminal end ladder sections and ladder section 80B serves as an intermediate ladder section. Although the use of three telescoping ladder sections is typical in the industry, ladder 20 may use only two of these ladder sections, or more than three of these ladder sections. Ladder sections 80 include respective rigid tubular uprights 82A-F and rigid rungs 84A-C. Each ladder section 80 thus includes a pair of axially spaced uprights and a rung which is substantially horizontal and extends axially between and is rigidly connected to the pair of uprights adjacent a respective end of each of the uprights, said ends serving as the lower ends when ladder 20 is its lowered position. The pair of uprights and rung of the given section 80 thus forms a rigid U-shaped configuration.

Each of uprights 82A and 82B is capped at its end opposite rung 84A by a circular end wall 86. Ladder section 80A further includes a pair of rigid pivots 88 which extend respectively outwardly from uprights 82A and 82B adjacent end walls 86 in opposite directions from one another. Each pivot 88 includes a neck 90 which is narrower or has a smaller diameter than the vertical width of slot 46 and is disposed therein. Each pivot 88 further has an enlarged head 92 which is secured to the outer end of neck 90 and has a larger width or diameter than slot 46. Necks 90 are respectively slidable within slots 46 back and forth in the longitudinal direction. A rigid reinforcing plate 94 is secured to each of uprights 82A and 82B adjacent end wall 86. When ladder 20 is in its lowered position, reinforcing plate 94 engages the rear surface of rear wall 37 of crossbar 34 while necks 90 of pivots 88 respectively engage the rear ends 50 of slots 46 whereby ladder 20 is supported in a matter to hang downwardly and angle slightly rearwardly from its pivotal connection with frame 18. More particularly, ladder 20 is pivotally connected to frame 18 about a substantially horizontal axis X (FIG. 9) which passes through the center of pivots 88. Rear wall 37 thus serves as a stop which is engaged by plates 94 in the lowered portion to limit rotation of ladder 20.

Left and right rails 30 and 32, as well as slots 46, are perpendicular to axis X and thus pivots 88 slide within slots 46 in a direction which is perpendicular to axis X. Uprights 82 are also substantially perpendicular to axis X whereby the telescoping linear movement of ladder sections 80B and 80C relative to one another and to section 80A is substantially perpendicular to axis X. It is noted however that the direction of this linear telescoping movement can change depending on the position to which ladder 20 has been pivoted about axis X. Thus, for example, when ladder 20 is in its lowered position, the telescoping movement is generally up and down whereas the linear telescoping movement may be horizontal and parallel to rails 30 and 32 and slots 46 when ladder 20 pivots to a generally horizontal position. The telescoping movement of ladder 20 thus may occur along any line perpendicular to axis X which is within the pivotal movement range of ladder 20 relative to frame 18. As is well known in the art, the telescopic extension of the ladder sections is limited by interferences therebetween, typically formed by annular flanges such as flanges 70 and 76 described previously with respect to spring assembly 60. In the exemplary embodiment, uprights 82C and 82D are respectively slidably received within the respective interior chambers of the tubular uprights 82A and 82B. Likewise, the uprights 82E and 82F of ladder section 80C are slidably received within the respective interior chambers of tubular uprights 82C and 82D. Adjacent its free or terminal end, ladder section 80C includes a pair of rods or posts 96 which extend respectively axially outwardly from uprights 82E and 82F in opposite directions away from one another in a cantilevered fashion.

Referring now to FIG. 3, the rear portion of rails 30 and 32 is described in greater detail. A J-shaped notch is formed in each side wall 42 extending forward from rear end 24 thereof. More particularly, notch 98 has a rear entrance opening 100 and extends forward therefrom, then downwardly and then forward to a forward terminal portion 102 which is spaced downwardly from entrance opening 100. Hook 56 includes a rear upwardly extending segment 104 and a forward extending segment 106 secured to and extending forward from the upper end of segment 104 to a forward terminal end so that forward extending segment 106 extends directly over forward terminal portion 102 of notch 98. Upwardly extending segment 104 defines a stop 108 in the form of a forward facing concavely curved surface which defines the rear of forward terminal portion 102 of notch 98. Hook 56 includes a cam surface 110 which in the exemplary embodiment is in the form of a convexly curved surface which extends forward from rear end 24 along segments 104 and 106 of hook 56. Cam surface 110 faces rearwardly and upwardly. Side wall 42 further includes an overhang or projection 112 which extends rearwardly and overhangs notch 98 with its rear terminal end overhanging segment 106 of hook 56 and forward terminal portion 102 of notch 98.

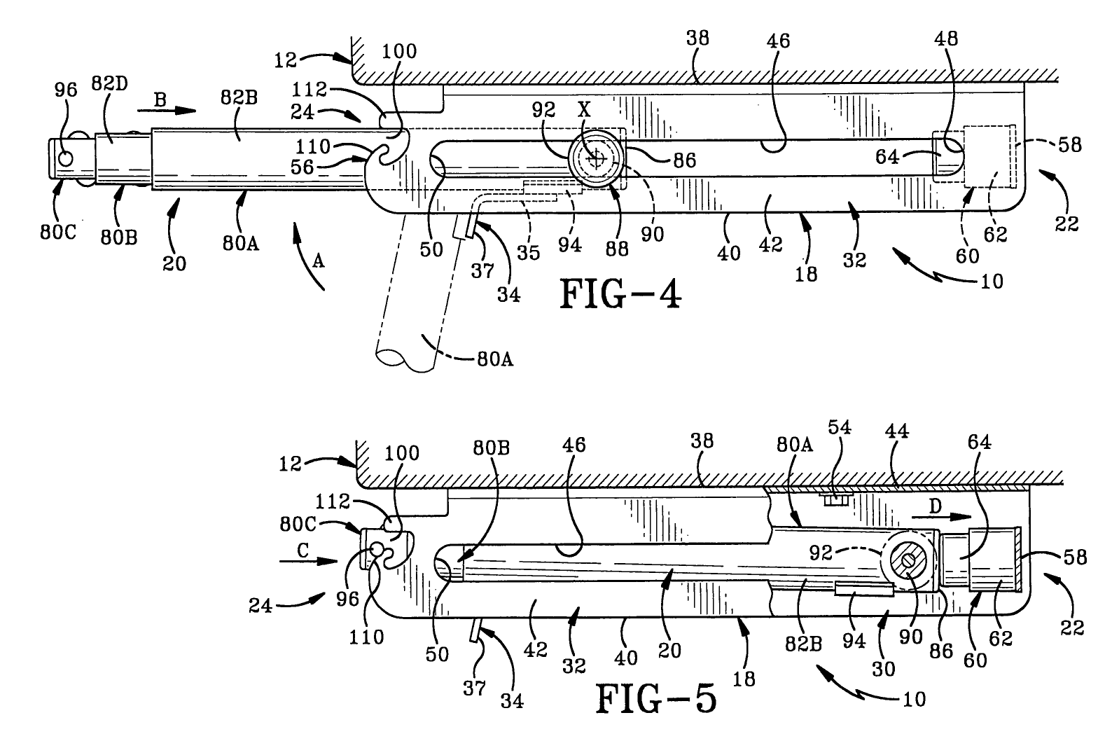

The operation of ladder assembly 10 is now described with primary reference to FIG. 4-12. FIG. 4 illustrates the initial steps in moving ladder 20 from its lowered and extended position of FIG. 2 (also shown in dot dash lines in FIG. 4) to the stowed position shown in FIGS. 8 and 9. More particularly, FIG. 4 shows ladder 20 pivoting upwardly about access X (arrow A) via the pivotal movement of necks 90 within respective slots 46. FIG. 4 also shows the retraction of ladder 20 (arrow B) as the uprights of ladder section 80B are slidably received within the uprights of section 80A, and the uprights of ladder section 80C are slidably received within the uprights of sections 80B and 80A. The pivotal movement of ladder 20 and its telescoping retraction may occur simultaneously or independently. The user achieves this pivotal movement and telescoping retraction simply by application of manual forces also illustrated by arrows A and B. The forward force also indicated by arrow B causes ladder 20 in its entirety to move forward with necks 90 of pivots 88 moving horizontally forward within notches 46 and slidably engaging the horizontal upwardly facing surfaces of sidewalls 42 which bound notches 46.

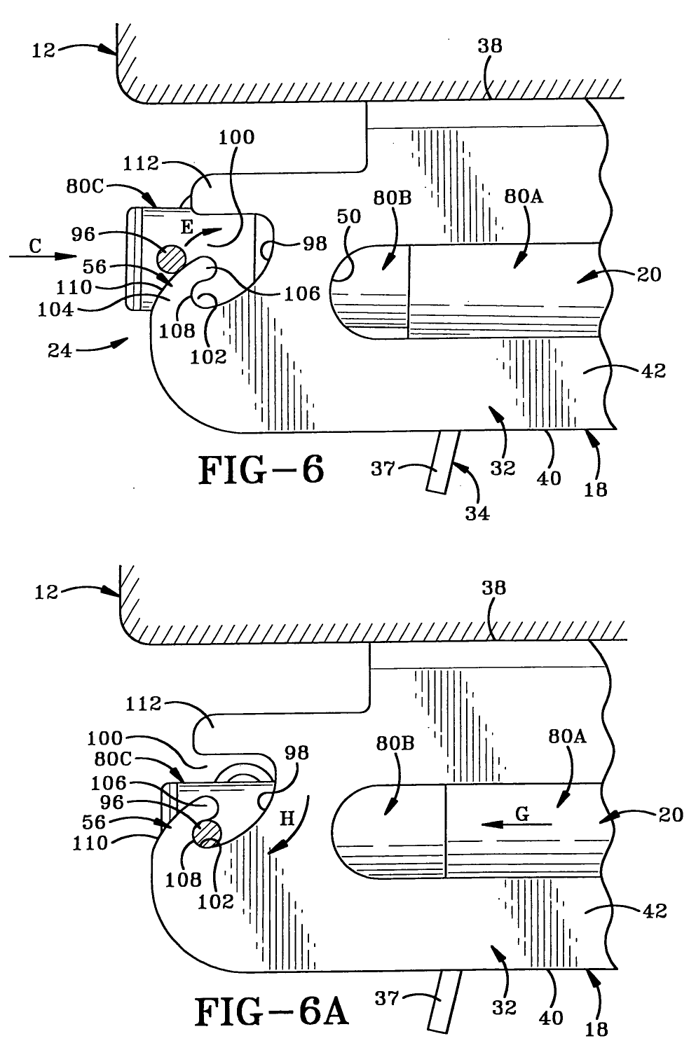

Continued forward force applied to ladder section 80C as indicated at arrow C in FIG. 5 causes posts 96 to engage cam surfaces 110, and end walls 86 of ladder sections 80A to engage the front of movable members 64 of spring assemblies 60, causing the initial forward movement of movable members 64, as indicated at arrow D. FIGS. 6 and 7 show the same stage of operation as FIG. 5. FIG. 6 illustrates that posts 96 slidably engage cam surfaces 110 in response to the force indicated by arrow C whereby posts 96 and the end of ladder 20 associated therewith move upwardly and forward (arrow E) as a result of this sliding engagement. Simultaneously, as shown in FIG. 7, end wall 86 engages end wall 74 of moveable member 64 so that movable member 64 moves forward and end wall 74 forces the rear end of spring 66 to move forward as spring 66 is compressed between end wall 74 and flange 58. It is noted that posts 96 may enter notch 98 without engaging cam surfaces 110; however, surfaces 110 help guide posts 96 into notches 98 if posts 98 engage surfaces 110. As the user pushes ladder 20 further forward as indicated at arrow F in FIG. 7A, spring 66 is further compressed. Meanwhile, posts 96 move over the top of hook 56 through entrance opening 100 and forward into notch 98 beyond the forward most portion of segment 106 of hook 56. The user then lowers the rear end of ladder 20 so that posts 96 are lowered within notches 98 sufficiently so that when the user releases ladder 20 or ceases a forward force to overcome the spring bias of spring 66, spring 66 expands to force movable member 64 and ladder 20 rearward (arrow G in FIG. 6A) so that post 96 moves into section 102 of notch 98 and into engagement with stop 108. The lowering and rearward movement of posts 96 is indicated at arrow H in FIG. 6A.

In the stowed position of ladder 20 illustrated in FIGS. 6A, 8 and 9, springs 66 thus apply a rearward force on ladder 20 which is in turn applied to stops 108 via posts 96. The rearward force applied by springs 66 thus clamps ladder 20 between movable member 54 and hooks 56 and also biases ladder 20 to its fully retracted position. In the stowed position, the front of movable member 64 is thus spaced rearwardly from flange 58, and annular flange 76 is typically spaced forward of annular flange 70 so that springs 66 are providing a rearward force on ladder 20. However, flange 76 in the stowed position may abut flange 70 whereby springs 66 are not applying a rearward force on ladder 20, but nonetheless resist forward movement of ladder 20 to prevent posts 96 from moving forward sufficiently to inadvertently be ejected out of notches 98 by vertical forces which may occur especially during travel of boat 14 along the water. In either case, the weight of ladder 20 adjacent posts 96 helps to keep posts 96 within notches 98, as does the interference between posts 96 and the overhanging segments 106 of hooks 56, which minimizes or eliminates upward movement of the rear end of ladder 20. In the stowed position of ladder 20, necks 90 are spaced forward of front ends 48 of slots 46. In the stowed position, all of uprights 82 are substantially horizontal and extend longitudinally parallel to rails 30 and 32 with end walls 86 serving as the front of ladder 20 which is disposed adjacent front end 22 of frame 18. Rungs 84 have moved from the vertically spaced orientation in the lowered position of ladder 20 to an orientation in the stowed position in which they lie substantially along a common horizontal plane and are longitudinally spaced and adjacent one another generally adjacent the rear end 24 of frame 18. Other relationships between the various components of ladder assembly 10 will be evident from the figures.

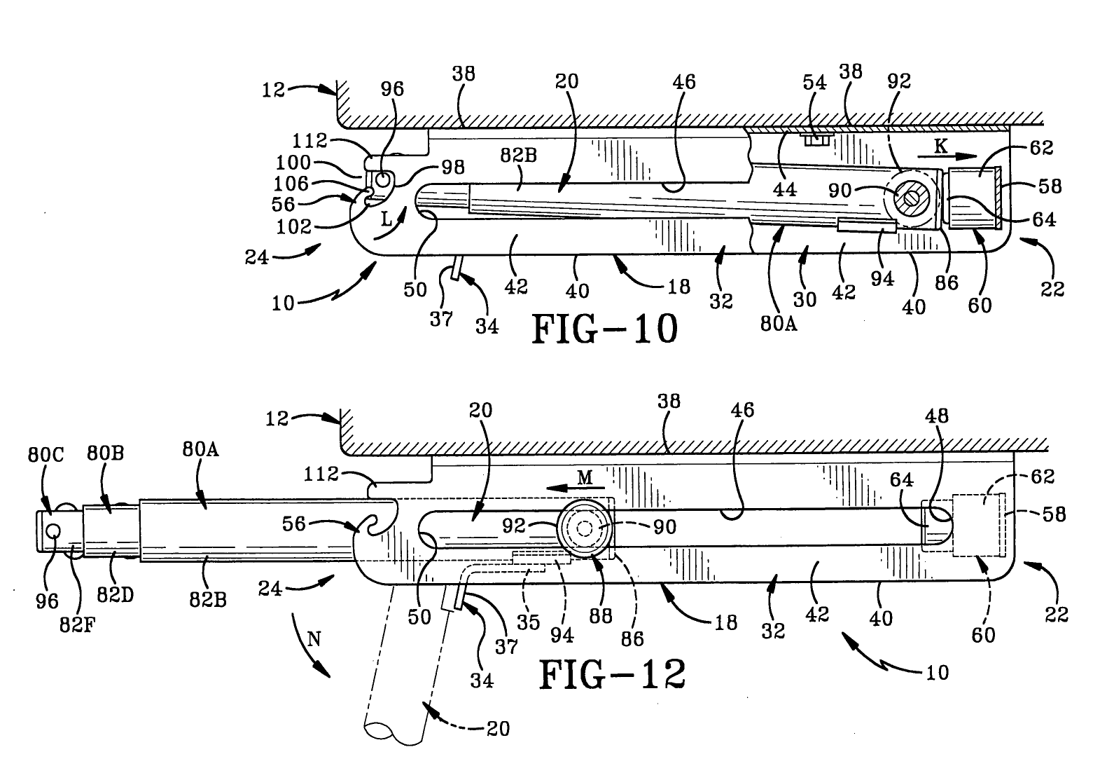

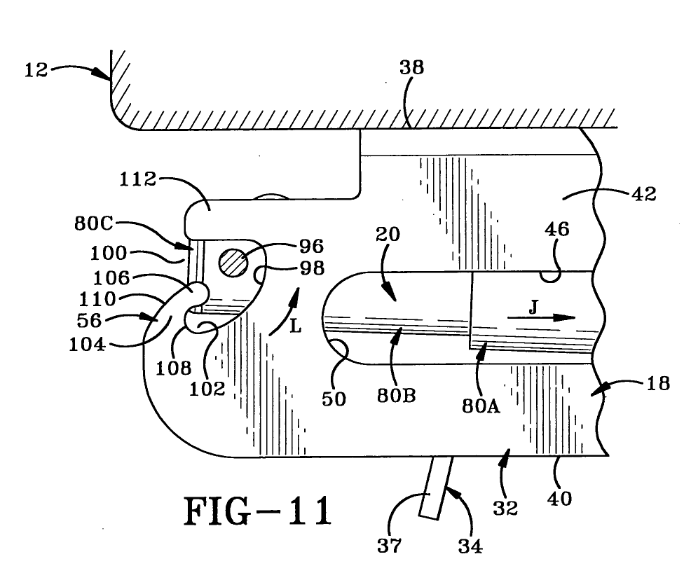

The movement of ladder 20 from its secured, retracted, and stowed position of FIGS. 8 and 9 to its fully extended and lowered position is illustrated in FIGS. 10-12. This movement is generally a reverse of the steps for moving the ladder to the stowed position. More particularly, the user simply applies a forward force (arrow J in FIG. 11) on ladder section 80C of ladder 20 in order to disengage posts 96 from stops 108 whereby the force is translated via ladder 20 to movable members 64 in order to move them forward as indicated at arrow K in FIG. 10. This force thus overcomes the spring bias of springs 66 as they are compressed. Once posts 96 clear the front of hooks 56, the user applies an upward force to move posts 96 upwardly above hooks 56, the forward and upward movement of posts 96 being indicated by arrows L in FIGS. 10 and 11. The user then moves ladder section 80C rearwardly so that posts 96 move rearwardly out of notches 98 via entrance openings 100 thereof. Even if the user did not apply an active rearward force, springs 66 would bias ladder 20 rearwardly so that posts 96 would move over the top of hooks 56. In any case, the user then pulls ladder 20 rearwardly so that sections 80 telescopically extend and pivots 88 slide horizontally rearwardly within slots 46 (arrow M in FIG. 12) until necks 90 of pivots 88 abut or are closely adjacent rear ends 50 of slots 46, at which point the entire ladder 20 is pivoted downwardly about pivots 88 (arrow N in FIG. 12) to the lowered position indicated in dot dash lines in FIG. 12. The pivotal lowering of ladder 20 will occur solely by force of gravity once the user releases ladder 20, that is, when the user is not applying an upward force on ladder 20 which would be sufficient to prevent this downward pivotal movement.

Spring 66 in the Figures is illustrated as a coil spring most typically formed of a spring metal. However, spring member 66 also symbolizes any other suitable resilient member. A resilient member for the purposes of the present application is defined as a member which is formed of a material which returns to its original shape or position after the removal of a stress that has produced elastic strain in the material. Thus, for example, spring member 60 may be formed of certain resilient plastic materials or elastomers. Although other spring members which utilize compressed gas or the like will work for the present application, they are generally less preferred inasmuch as gas leakage can minimize or eliminate their effectiveness, and they tend to be more costly and more complicated in structure.

The invention thus far has been described as using spring assembly 60 which is mounted on frame 18. However, spring assembly 60 or a mechanism serving a similar purpose may be mounted in other locations including on the ladder. By the way of example, FIG. 2 illustrates in dashed lines alternate spring assemblies at 160A and 160B which are analogous to spring assembly 60. More particularly, spring assemblies 160A may be positioned inside the interior chamber of the tubular uprights 82 in any of the ladder sections although they are shown positioned in dashed lines at the upper ends of uprights 82A and 82B. Spring assemblies 160B are illustrated as being mounted on the bottom of rung 84B adjacent its opposed ends. Where spring assemblies such as 160A and 160B are utilized instead of spring assemblies 60, the overall operation is very similar to that previously described with respect to the use of spring assemblies 60. However, whereas spring assemblies 60 bias the entire ladder 20 forward in the stowed position, spring assemblies 160A bias ladder sections 80B and 80C rearwardly in the stowed position relative to ladder section 80A. In addition, the use of spring assemblies 160A in place of spring assemblies 60 results in necks 90 of pivots 88 engaging front ends 48 of slots 46 in the stowed position, whereby front ends 48 serve as stops for limiting the forward movement of ladder section 80A. Where spring assemblies 160B are used in place of spring assemblies 60, front ends 48 likewise serve as stops, limiting the forward movement of ladder section 80A as well as ladder section 80B via its engagement with ladder section 80A. Spring assemblies 160B would thus engage the upper surfaces of rung 84C in the stowed position to bias ladder section 80C rearwardly relative to ladder sections 80A and 80B. It is noted that when spring assemblies 60 are used, ladder 20 is fully retracted in the stowed position, which is not the case with the use of spring assemblies 160A or 160B. When spring assemblies 160A are used, ladder section 80C may be fully retracted within ladder section 80B, but ladder section 80B will not be fully retracted within ladder section 80A in the stowed position. However, section 80B is nearly fully retracted within section 80A when spring assemblies 160A are used. Similarly, when spring assemblies 160B are used, ladder 20 is not fully retracted in the stowed position, but is nearly fully retracted. More particularly, ladder section 80B is fully retracted within ladder section 80A, and ladder section 80C is nearly fully retracted within ladder section 80B in the stowed position when spring assemblies 160B are used.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A telescoping ladder assembly comprising:
a first stop;
a ladder comprising a plurality of telescoping ladder sections whereby the ladder is telescopically extendable and retractable to respectively lengthen and shorten the ladder;
a first one of the ladder sections telescopically movable relative to the first stop; and
a spring member which biases the first ladder section and first stop against one another when the ladder is retracted to prevent telescopic extension of the first ladder section.

2. The ladder assembly of claim 1 wherein the first ladder section comprises a post; and the spring member biases the post and first stop against one another when the ladder is retracted to prevent telescopic extension of the first ladder section.

3. The ladder assembly of claim 1 wherein the spring member is part of a spring assembly comprising a first member and a second member movably mounted on the first member; and the spring member is disposed between the first and second members.

4. The ladder assembly of claim 3 wherein the first member is telescopically received within the second member.

5. The ladder assembly of claim 4 wherein the first member has a cup-shaped configuration.

6. The ladder assembly of claim 1 wherein the ladder is pivotable relative to the first stop between a lowered position and a raised position.

7. The ladder assembly of claim 1 further comprising a frame; and wherein the ladder is movably mounted on the frame.

8. The ladder assembly of claim 7 wherein the ladder is pivotally mounted on the frame whereby the ladder is pivotable between a lowered position and a raised position.

9. The ladder assembly of claim 8 further comprising front and rear ends on the frame; and wherein the ladder is slidably mounted on the frame to alternately slide forward and rearward along the frame.

10. The ladder assembly of claim 9 wherein the front and rear ends define therebetween a longitudinal direction; the frame comprises a pair of rails; a longitudinally elongated slot is formed in each rail; a pair of pivots are mounted on the ladder; and the pivots are pivotable and longitudinally slidable within the respective slots.

11. The ladder assembly of claim 8 further comprising a second stop on the frame; and wherein the ladder engages the second stop in the lowered position to limit pivotal movement of the ladder.

12. The ladder assembly of claim 7 wherein the first stop is on the frame.

13. The ladder assembly of claim 12 further comprising a notch formed in the frame; and wherein the first stop defines a portion of the notch; and the first ladder section comprises a post which is movable between a first position within in the notch and a second position external to the notch.

14. The ladder assembly of claim 13 wherein the frame comprises a hook which defines the first stop.

15. The ladder assembly of claim 7 wherein the frame comprises a pair of longitudinal rails and an axial crossbar extending between and connected to the rails.

16. The ladder assembly of claim 7 wherein the frame carries the spring member.

17. The ladder assembly of claim 7 further comprising a mounting mechanism configured for mounting the frame on a support platform.

18. The ladder assembly of claim 1 wherein each ladder section comprises a pair of uprights and a rung extending between and connected to the uprights.

19. The ladder assembly of claim 18 wherein the uprights of the first ladder section are respectively slidably received within the uprights of a second one of the ladder sections.

20. The ladder assembly of claim 1 wherein the ladder carries the spring member.
